(19) United States
(12) Patent Application Publication
(10) Pub. No.: US 2012/0253784 A1
(43) Pub. Date: Oct. 4, 2012

(54) LANGUAGE TRANSLATION BASED ON NEARBY DEVICES

(75) Inventors: Sameer Maskey, New York, NY (US); Dimitri Kanevasky, Ossining, NY (US); Tara N. Sainath, New York, NY (US); Bhuvana Ramabhadran, Mount Kisco, NY (US)

(73) Assignee: International Business Machines Corporation, Armonk, NY (US)

(21) Appl. No.: 13/077,110

(22) Filed: Mar. 31, 2011

(51) Int. Cl. G06F 17/28

(52) U.S. Cl. 704/3; 704/E11.001

(57) ABSTRACT

A device, method, and computer program for performing language translation. An example embodiment may include a communications module configured to receive device data from a nearby device. A constraint module is configured to limit a translation domain of the language translation based on the device data. Language translation is performed within the limited translation domain.

### BACKGROUND

The present invention relates generally to language translation. More specifically, the present invention relates to use of a nearby device for improving language translation accuracy.

A language translation device allows users to input words and sentences in a natural language, and provides the user with a translation of the input in another natural language. Both input and output to a language translation device may be in the form of speech or text. To perform the translation, the device decodes the meaning of the input and then re-encodes the meaning into the second language. Thus, the device typically requires in-depth knowledge of both languages. When words have multiple meanings, a translation device can use different techniques to perform disambiguation and determine the correct translation. One example technique is to restrict the domain of the language translation.

### SUMMARY

An example embodiment of the present invention is a translation device for performing language translation. The translation device includes a communications module and a constraint module. The communications module is configured to receive device data from a nearby device external to the translation device. The constraint module is configured to limit a translation domain of the language translation based on the device data.

Another example embodiment of the invention is a method for improving language translation accuracy. The method includes a receiving step for receiving device data from a nearby device. A limiting step limits a translation domain of the language translation based on the device data.

Yet another example embodiment of the invention is a computer program product for performing language translation. The computer program product includes computer readable program code configured to receive device data from a nearby device, and limit a translation domain of the language translation based on the device data.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 shows a block diagram of an example translation device in accordance with the present invention.

FIG. 2 shows a flowchart for a process to perform language translation in accordance with an embodiment of the present invention.

### DETAILED DESCRIPTION

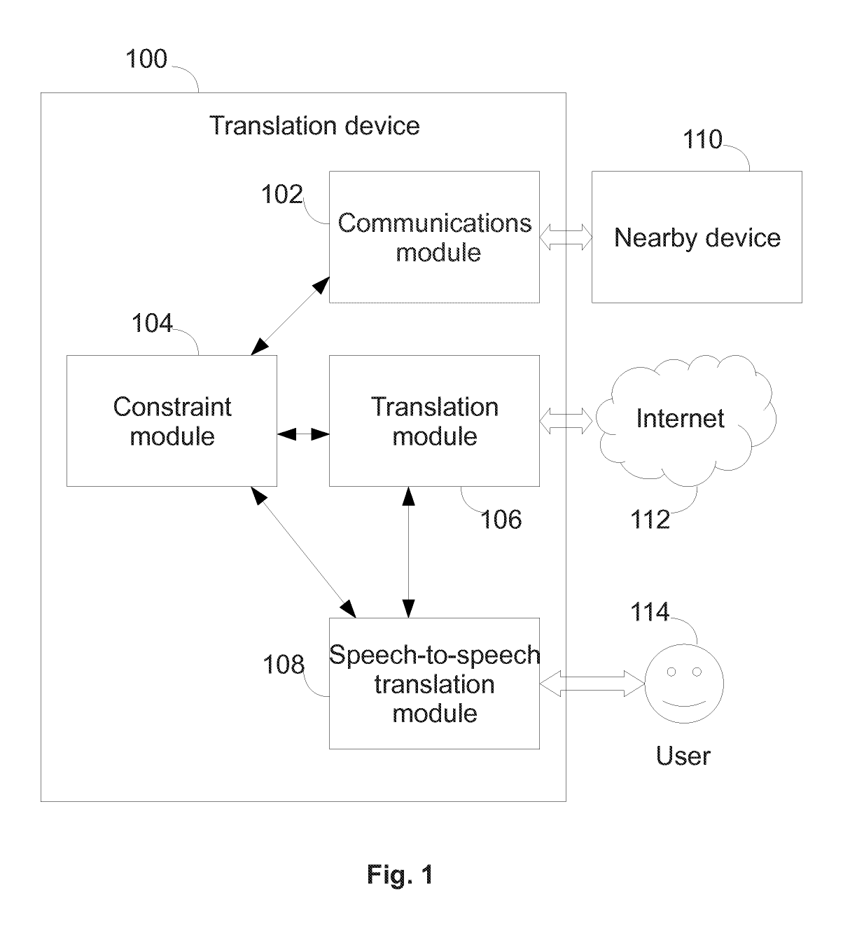

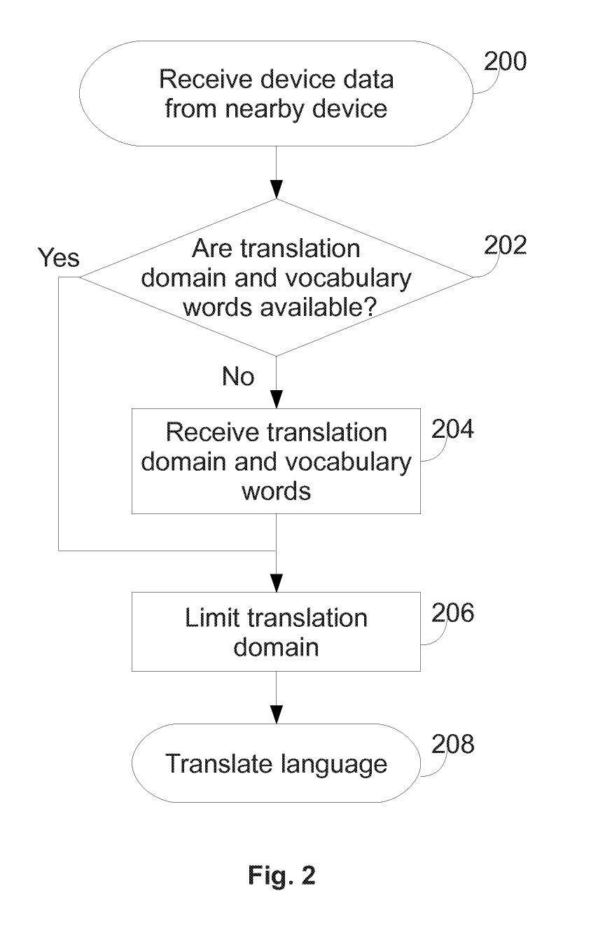

The present invention is described with reference to embodiments of the invention. Throughout the description of the invention reference is made to FIGS. 1-2.

FIG. 1 shows a block diagram of an example translation device 100 in accordance with the present invention. The translation device 100 contains a communications module 102 that receives device data from a nearby device 110 external to the translation device 100. The device data can be received through any means of communication, including a wired connection or a wireless connection. Examples of wireless communication include Wi-Fi®, Bluetooth®, and near-field communications. The device data can include data for identifying the purpose of the nearby device 110 and also measurements taken by the nearby device 110. For example, if the nearby device 110 is a blood pressure machine, the device data could include data identifying the nearby device 110 as medical equipment for measuring blood pressure. Furthermore, the device data may include the blood pressure measurement reading taken by the nearby device 110.

The device data is passed from the communications module 102 to the constraint module 104. The constraint module 104 uses the device data to limit the translation domain of the language translation. The translation domain is limited by restricting the vocabulary, search space, grammar, and/or language model used for the language translation. For example, if the device data is from a blood pressure machine, the translation domain would be restricted to medical terms relating to blood pressure. If the translation domain and vocabulary is not already available on the translation device 100, a translation module 106 can retrieve the translation domain and vocabulary words from an external source, such as the Internet 112 or the nearby device 110. The translation module 106 can also be used to retrieve additional information, such as GPS location, which can be used by the constraint module 104 to further restrict the translation domain.

The translation device 100 can also contain a speech-to-speech translation module 108. This allows the user 114 to use spoken words as input for the translation device 100, and the translated language can be audibly output back to the user 114.

FIG. 2 is a flowchart for a process to perform language translation in accordance with an embodiment of the present invention. The process starts at receiving operation 200. During the receiving operation 200, data is received from a nearby device. As mentioned above, the device data can include data identifying the purpose of the nearby device and also measurements taken by the nearby device. The device data can be received through various means of communication known to those skilled in the art. After receiving operation 200 is completed, control passes to decision operation 202.

At decision operation 202, the translation device determines whether the translation domain and/or vocabulary words for a translation based on the device data is available to the translation device. If so, control passes to limiting operation 206. Otherwise, control passes to receiving operation 204.

At receiving operation 204, the translation device receives the translation domain and/or vocabulary words required for translation based on the device data. As mentioned above, the translation domain and vocabulary words may be retrieved from an external source, such as the Internet or the nearby device. After receiving operation 204 is completed, control passes to limiting operation 206.

At limiting operation 206, the translation domain of the language translation is limited using the device data. As discussed above, the translation domain is limited by restricting the vocabulary, search space, grammar, and/or language model used for the language translation. Once the limiting operation 206 is completed, the process continues to translating operation 208.

At translating operation 208, the language is translated using the limited translation domain. The language input and translated output can be in any form, such as spoken or typed. Thus, the translating operation 208 may include recognizing spoken words and audibly outputting the language translation of the spoken words.

As will be appreciated by one skilled in the art, aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the C programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preferred embodiments to the invention has been described, it will be understood that those skilled in the art, both now and in the future, may make various improvements and enhancements which fall within the scope of the claims which follow. Thus, the claims should be construed to maintain the proper protection for the invention first described.

What is claimed is:

1. A translation device for performing language translation, the translation device comprising:
a communications module to receive device data from a nearby device external to the translation device; and
a constraint module to limit a translation domain of the language translation based on the device data.

2. The translation device of claim 1, further comprising:
wherein the device data includes data for identifying the purpose of the nearby device; and
wherein the constraint module is configured to limit the translation domain of the language translation based on the identified purpose of the nearby device.

3. The translation device of claim 1, wherein the communication module includes at least one interface to receive the device data through at least one of bluetooth, wifi, and near field communications.

4. The translation device of claim 1, wherein the constraint module limits the translation domain by a restriction on at least one of vocabulary, search space, grammar, and language model used for the language translation.

5. The translation device of claim 1, further comprising:
wherein the device data includes measurement data from the nearby device; and
wherein the constraint module is configured to limit the translation domain of the language translation based on the measurement data.

6. The translation device of claim 1, further comprising a translation module to receive at least one of the translation domain based on the device data and vocabulary words based on the device data.

7. The translation device of claim 1, further comprising a speech-to-speech translation module to recognize spoken words and audibly output the language translation of the spoken words.

8. A method for improving language translation accuracy, the method comprising:
receiving device data from a nearby device; and
limiting a translation domain of the language translation based on the device data.

9. The method of claim 8, further comprising:
wherein the device data includes data for identifying the purpose of the nearby device;
identifying the purpose of the nearby device; and
limiting the translation domain of the language translation based on the purpose of the nearby device.

10. The method of claim 8, wherein the device data is received through at least one of bluetooth, wifi, and near field communications.

11. The method of claim 8, wherein limiting the translation domain comprises limiting by a restriction on at least one of vocabulary, search space, grammar, and language model used for language translation.

12. The method of claim 8, further comprising:
wherein the device data includes measurement data from the nearby device; and
limiting the translation domain of the language translation based on the measurement data.

13. The method of claim 8, further comprising receiving at least one of the translation domain based on the device data and vocabulary words based on the device data.

14. The method of claim 8, further comprising recognizing spoken words and audibly outputting the language translation of the spoken words.

15. A computer program product for performing language translation comprising:
a computer readable storage medium having computer readable program code embodied therewith, the computer readable program code configured to:
receive device data from a nearby device; and
limit a translation domain of the language translation based on the device data.

16. The computer program product of claim 15, further comprising:
wherein the device data includes data for identifying the purpose of the nearby device; and
wherein the computer readable program code is further configured to limit the translation domain of the language translation based on the purpose of the nearby device.

17. The computer program product of claim 15, wherein the translation domain is limited by a restriction on at least one of vocabulary, search space, grammar, and language model used for language translation.

18. The computer program product of claim 15, further comprising:
wherein the device data includes measurement data from the nearby device; and
wherein the computer readable program code is further configured to limit the translation domain of the language translation based on the measurement data from the nearby device.

19. The computer program product of claim 15, wherein the computer readable program code is further configured to receive at least one of the translation domain based on the device data and vocabulary words based on the device data.

20. The computer program product of claim 15, wherein the computer readable program code is further configured to recognize spoken words and audibly output the language translation of the spoken words.
